(19) United States
(12) Patent Application Publication
(10) Pub. No.: US 2025/0178860 A1
(43) Pub. Date: Jun. 5, 2025

(54) AN ELEVATOR SYSTEM

(71) Applicant: KONE CORPORATION, Helsinki (FI)

(72) Inventors: Ari Jussila, Helsinki (FI); Toni Hirvonen, Helsinki (FI); Atso Koskinen, Helsinki (FI)

(73) Assignee: KONE CORPORATION, Helsinki (FI)

(21) Appl. No.: 19/047,230

(22) Filed: Feb. 6, 2025

Related U.S. Application Data
(63) Continuation of application No. PCT/EP2022/073661, filed on Aug. 25, 2022.

(51) Int. Cl. B66B 1/34

(52) U.S. Cl. CPC B66B 1/3453; B66B 1/3492

(57) ABSTRACT

According to an aspect, there is provided an elevator system comprising a serial data communication system, an elevator controller communicatively connected to the serial data communication system and at least one elevator system node communicatively connected to the serial data communication system. An elevator system node of the at least one elevator system node is configured to register an event associated with an elevator car; determine event data associated with the event; determine timing data associated with the event; and send a message via the serial data communication system to the elevator controller, the message comprising the event data and the timing data. The elevator controller is configured to receive the message via the serial data communication system; and determine an estimated value of an elevator car control parameter based on the event data and the timing data.

### BACKGROUND

Elevator systems may use various sensors for determining a position of an elevator car in an elevator shaft. The determination may be based, for example, on magnets. The magnets may be used to determine, whether the elevator car is in a correct position in the elevator shaft or whether should still be moved in order to reach the correct position.

At the same time, an elevator system may use serial data transfer in transmitting various messages associated with the elevator system and its elements. Depending on the sensor implementation for determining the position of the elevator car in the elevator shaft, it may happen that the sensors are not able to detect the position of the elevator car correctly in the elevator shaft when the speed of the elevator car exceeds a predefined threshold speed.

### SUMMARY

According to a first aspect, there is provided an elevator system comprising a serial data communication system, an elevator controller communicatively connected to the serial data communication system and at least one elevator system node communicatively connected to the serial data communication system. An elevator system node of the at least one elevator system node is configured to register an event associated with an elevator car; determine event data associated with the event; determine timing data associated with the event; and send a message via the serial data communication system to the elevator controller, the message comprising the event data and the timing data.

The elevator controller is configured to receive the message via the serial data communication system; and determine an estimated value of an elevator car control parameter based on the event data and the timing data.

In an implementation form of the first aspect, the timing data comprises time since registering the event.

In an implementation form of the first aspect, the timing data comprises a time stamp of time when registering the event.

In an implementation form of the first aspect, the event data comprises at least one of: a position of the elevator car and a speed of the elevator car.

In an implementation form of the first aspect, the estimated value of the elevator control parameter comprises at least one of a current speed of the elevator car and a current position of the elevator car.

In an implementation form of the first aspect, the serial data communication bus comprises a safety bus applying a time-triggered communication protocol.

In an implementation form of the first aspect, the elevator system node is arranged in the elevator car.

According to a second aspect, there is provided an elevator system node communicatively connected to a serial data communication system. The elevator system node comprises means for registering an event associated with an elevator car, means for determining event data associated with the event, means for determining timing data associated with the event, and means for sending a message via the serial data communication system to an elevator controller, the message comprising the event data and the timing data.

In an implementation form of the second aspect, the timing data comprises time since registering the event.

In an implementation form of the second aspect, the timing data comprises a time stamp of time when registering the event.

In an implementation form of the second aspect, the event data comprises at least one of: a position of the elevator car and a speed of the elevator car.

In an implementation form of the second aspect, the serial data communication bus comprises a safety bus applying a time-triggered communication protocol.

In an implementation form of the second aspect, the elevator system node is arranged in the elevator car.

According to a third aspect, there is provided an elevator controller communicatively connected to a serial data communication system. The elevator controller comprises means for receiving a message via the serial data communication system, the message comprising event data relating to an event associated with an elevator car and timing data associated with the event; and means for determining an estimated value of an elevator car control parameter based on the event data and the timing data.

In an implementation form of the third aspect, the timing data comprises time since registering the event.

In an implementation form of the third aspect, the timing data comprises a time stamp of time when registering the event.

In an implementation form of the third aspect, the event data comprises at least one of: a position of the elevator car and a speed of the elevator car.

In an implementation form of the third aspect, the serial data communication bus comprises a safety bus applying a time-triggered communication protocol.

In an implementation form of the third aspect, the estimated value of the elevator control parameter comprises at least one of a current speed of the elevator car and a current position of the elevator car.

According to a fourth aspect, there is provided a method that comprises registering an event associated with an elevator car, determining event data associated with the event, determining timing data associated with the event, sending a message via a serial data communication system to an elevator controller, the message comprising the event data and the timing data.

According to a fifth aspect, there is provided a method that comprises receiving a message via a serial data communication system, the message comprising event data relating to an event associated with an elevator car and timing data associated with the event; and determining an estimated value of an elevator car control parameter based on the event data and the timing data.

According to a sixth aspect, there is provided a computer program comprising instructions stored thereon for performing at least the following: registering an event associated with an elevator car; determining event data associated with the event; determining timing data associated with the event; and sending a message via a serial data communication system to an elevator controller, the message comprising the event data and the timing data.

According to a seventh aspect, there is provided a computer program comprising instructions stored thereon for performing at least the following: receiving a message via a serial data communication system, the message comprising event data relating to an event associated with an elevator car and timing data associated with the event; and determining an estimated value of an elevator car control parameter based on the event data and the timing data.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a block diagram of an elevator system according to an example embodiment.

FIG. 2 illustrates communication cycles used in an elevator communication system between at least one elevator system node and an elevator controller according to an example embodiment.

FIG. 3 illustrates an apparatus according to an example embodiment.

### DETAILED DESCRIPTION

Various examples and embodiments discussed herein disclose a solution in which limitations of serial message transfer frequency may be overcome in an elevator positioning system.

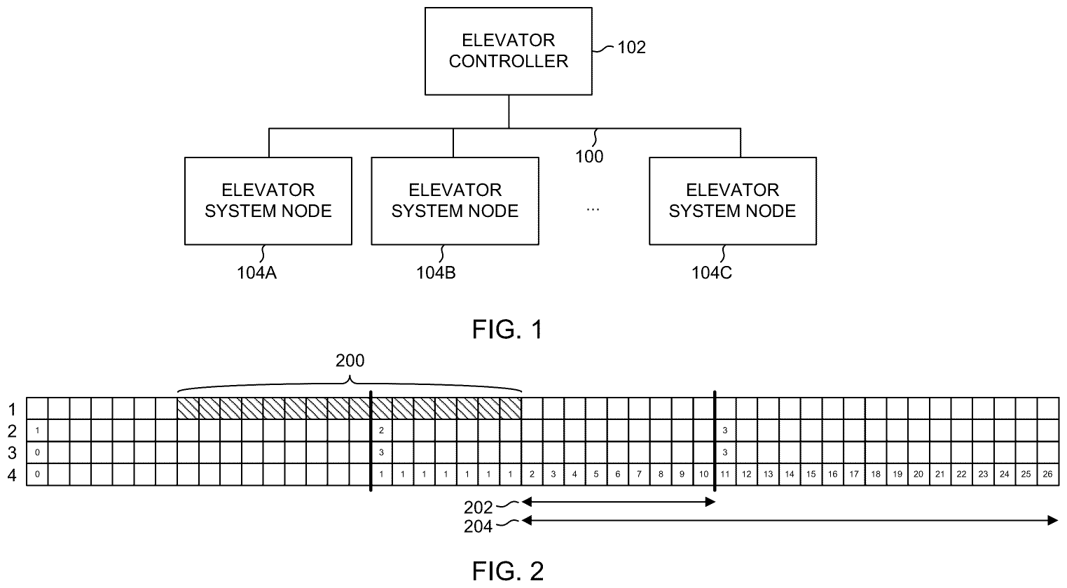

FIG. 1 illustrates a block diagram of an elevator system according to an example embodiment. The elevator system comprises a serial data communication system 100, an elevator controller 102 communicatively connected to the serial data communication system 100 and at least one elevator system node 104A, 104B, 104C communicatively connected to the serial data communication system 100. The serial data communication bus comprise, for example, a safety bus applying a time-triggered communication protocol. In an example embodiment, the elevator system node 104A, 104B, 104C may be arranged in an elevator car. In an example embodiment, the elevator system node(s) may be mounted in predefined position(s) in an elevator shaft, next to the elevator car trajectory.

The elevator system node 104A, 104B, 104C may be configured to register an event associated with an elevator car. The event may be, for example, an elevator car positioning event. The elevator system node 104A, 104B, 104C may be configured to determine event data associated with the event, determine timing data associated with the event and send a message via the serial data communication system 100 to the elevator controller 102, the message comprising the event data and the timing data. In an example embodiment, the event data may comprise elevator car position and/or elevator car speed data at the moment of an indication that the elevator car has arrived to a predefined position in elevator shaft. The elevator car position data may be obtained, for example, from elevator car position sensor reading magnets mounted in predefined positions in an elevator shaft, for example, in landing door zones. The timing data may refer, for example, to time since registering the event or a time stamp of time when registering the event.

The elevator controller 102 is configured to receive the message sent by the elevator system node 104A, 104B, 104C and determine an estimated value of an elevator car control parameter based on the event data and the timing data. In an example embodiment, the estimated value of the elevator car control parameter may comprise at least one of a current speed of the elevator car and a current position of the elevator car.

FIG. 2 illustrates communication cycles used in an elevator communication system between at least one elevator system node and an elevator controller according to an example embodiment. The illustrated example may use, for example, a time-triggered communication protocol. The elevator system node may be configured to report the position of an elevator car repeatedly in communication cycles, for example, once in every 16 ms.

One or more elevator car position sensor readers, for example, elevator car position sensor reading magnets, may be mounted in predefined positions in an elevator shaft, for example, in landing door zones. The elevator car position sensor reading magnets may be used in determining position of the elevator car in the elevator shaft. The communication protocol illustrated in FIG. 2 uses serial data communication that comprises successive communication cycles, and in this example embodiment, the length of each communication cycle is 16 ms.

The example embodiment illustrated in FIG. 2 discloses a solution in which a linear position of an elevator car may be obtained also in a case in which a reader reading an elevator car position sensor reading magnet is on the magnet a shorter time than what is the length of the communication cycle, i.e. 16 ms in this example. In an example embodiment, the event data may be transmitted via the time-triggered communication protocol to an elevator controller for a minimum of three consecutive communication cycles. The event data may comprise, for example, at least one of a magnet type, linear position of the elevator car and a calculated speed of the elevator car. In addition to this information, an elevator system node associated with the elevator car may be configured to determine timing data associated with the event and send the timing data to the elevator controller. The timing data may comprise, for example, time since registering the event or a time stamp of time when registering the event.

In FIG. 2, the first row indicates the time 200 during which the magnet is detected. The second row indicates the number of the communication cycle. The third row indicates the magnet type. The fourth row indicates elevator car position data update time, i.e. the time elapsed between the latest internal update of linear data and the current time. The reference signs 202, 204 indicate the time elapsed after the magnet exited the reader.

In an example embodiment, if the magnet has not been indicated for the minimum number of communication cycles and the reader no longer detects the magnet, the latest values read before magnet type was changed may be used and the linear data update time may be updated. Further, in an example embodiment, if the next magnet is read before data relating to the previous magnet has been sent a minimum number of times, the data read relating to the next magnet may be sent instead and a timer counting the minimum number of times for that magnet may be restarted.

In an example embodiment, the elevator controller may be configured to receive the data sent by the elevator system node and determine an estimated value of an elevator car control parameter based on the event data and the timing data. The estimated value of the elevator control parameter may comprise at least one of a current speed of the elevator car and a current position of the elevator car. For example, the timing data obtained from the elevator system node may be used for adjusting the position of the elevator car.

Absolution position calculations of the elevator car may be performed, for example, in the following way. The elevator controller may use the timing data (T_{dzs}) in the calculations when it is determining the absolute position of the elevator car (X_{abs}) based on a linear position (Xₗᵢₙ), the current speed (V_{cur}) and a relative position (Xᵣₑₗ) from an absolute position sensor. In an example embodiment, a compensated absolute position of the magnet (X_{abs}) is X_{abs}=Xᵣₑₗ−Xₗᵢₙ+V_{cur}*T_{dzs}.

The example illustrated in FIG. 2 uses positioning magnets in determining the position of the elevator car. In other example embodiments, other implementations may also be used, for example, an inductive based solution, a bar code based solution, a magnetic field based solution, a camera based solution etc.

At least one of the examples and embodiments disclosed above may provide a solution that alleviate the limitations of the magnet reading and serial communication based positioning system and the positioning system will not be the limiting factor for higher speed elevators. Further, at least one of the examples and embodiments disclosed above may provide a solution that makes it possible to adjust the absolute position also with speeds when magnet is passed within one communication cycle. Further, at least one of the examples and embodiments disclosed above may provide a solution that makes the implementation more robust against disturbances in the communication network. Further, at least one of the examples and embodiments disclosed above may enable a solution in which more accurate information of the current elevator car position or the current elevator car speed may be obtained despite the time delay.

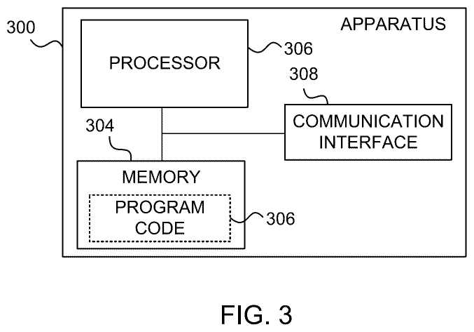

FIG. 3 illustrates an apparatus 300 according to an example embodiment. The apparatus 300 may implement functionality of the elevator system node 104A, 104B, 104C and/or the elevator controller 102.

The apparatus 300 comprises one or more processors 302, and one or more memories 304 that comprise computer program code. The apparatus 300 may also comprise a communication interface 308. The communication interface 308 may provide a wired or a wireless connection to other entities, for example, via the Internet or some other communication network. Although the apparatus 300 is depicted to include only one processor 302, the apparatus 300 may include more than one processor. In an example embodiment, the memory 304 is capable of storing instructions, such as an operating system and/or various applications.

Furthermore, the processor 302 is capable of executing the stored instructions. In an example embodiment, the processor 302 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 302 may be configured to execute hard-coded functionality. In an example embodiment, the processor 302 is embodied as an executor of software instructions, wherein the instructions may specifically configure the processor 302 to perform the algorithms and/or operations described herein when the instructions are executed.

The memory 304 may be embodied as one or more volatile memory devices, one or more non-volatile memory devices, and/or a combination of one or more volatile memory devices and non-volatile memory devices. For example, the memory 304 may be embodied as semiconductor memories (such as mask ROM, PROM (programmable ROM), EPROM (erasable PROM), flash ROM, RAM (random access memory), etc.).

In an embodiment, the at least one memory 304 may store program instructions 306 that, when executed by the at least one processor 302, cause the apparatus 300 to perform the functionality of the various embodiments discussed herein. Further, in an embodiment, at least one of the processor 302 and the memory 304 may constitute means for implementing the discussed functionality.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps s which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1.-11. (canceled)

12. An elevator system, comprising:
a serial data communication system;
an elevator controller communicatively connected to the serial data communication system; and
at least one elevator system node communicatively connected to the serial data communication system;
wherein an elevator system node of the at least one elevator system node is configured to
register an event associated with an elevator car;
determine event data associated with the event;
determine timing data associated with the event, the timing data comprising the time since registering the event or a time stamp of the time when registering the event;
send a message via the serial data communication system to the elevator controller, the message comprising the event data and the timing data;
wherein the elevator controller is configured to
receive the message via the serial data communication system; and
determine an estimated value of an elevator car control parameter based on the event data and the timing data.

13. The elevator system of claim 12, wherein the event data comprises at least one of: an elevator car position and a speed of the elevator car.

14. The elevator system of claim 12, wherein the estimated value of the elevator control parameter comprises at least one of a current speed of the elevator car and a current position of the elevator car.

15. The elevator system of claim 12, wherein the serial data communication bus comprises a safety bus applying a time-triggered communication protocol.

16. The elevator system of claim 12, wherein the elevator system node is arranged in the elevator car.

17. An elevator system node communicatively connected to a serial data communication system, the elevator system node comprising:
means for registering an event associated with an elevator car;
means for determining event data associated with the event;
means for determining timing data associated with the event, the timing data comprising the time since registering the event or a time stamp of the time when registering the event; and
means for sending a message via the serial data communication system to an elevator controller, the message comprising the event data and the timing data.

18. An elevator controller communicatively connected to a serial data communication system, the elevator controller comprising:
means for receiving a message via the serial data communication system, the message comprising event data relating to an event associated with an elevator car and timing data associated with the event, the timing data comprising the time since registering the event or a time stamp of the time when registering the event; and
means for determining an estimated value of an elevator car control parameter based on the event data and the timing data.

19. A method comprising:
registering an event associated with an elevator car;
determining event data associated with the event;
determining timing data associated with the event, the timing data comprising the time since registering the event or a time stamp of the time when registering the event; and
sending a message via a serial data communication system to an elevator controller, the message comprising the event data and the timing data.

20. A method comprising:
receiving a message via a serial data communication system, the message comprising event data relating to an event associated with an elevator car and timing data associated with the event, the timing data comprising the time since registering the event or a time stamp of the time when registering the event; and
determining an estimated value of an elevator car control parameter based on the event data and the timing data.

21. A non-transitory computer readable medium storing a computer program comprising instructions stored thereon for performing at least the following:
registering an event associated with an elevator car;
determining event data associated with the event;
determining timing data associated with the event, the timing data comprising the time since registering the event or a time stamp of the time when registering the event; and
sending a message via a serial data communication system to an elevator controller, the message comprising the event data and the timing data.

22. A non-transitory computer readable medium storing a computer program comprising instructions stored thereon for performing at least the following:
receiving a message via a serial data communication system, the message comprising event data relating to an event associated with an elevator car and timing data associated with the event, the timing data comprising the time since registering the event or a time stamp of the time when registering the event; and
determining an estimated value of an elevator car control parameter based on the event data and the timing data.

23. The elevator system of claim 13, wherein the estimated value of the elevator control parameter comprises at least one of a current speed of the elevator car and a current position of the elevator car.

24. The elevator system of claim 13, wherein the serial data communication bus comprises a safety bus applying a time-triggered communication protocol.

25. The elevator system of claim 14, wherein the serial data communication bus comprises a safety bus applying a time-triggered communication protocol.

26. The elevator system of claim 13, wherein the elevator system node is arranged in the elevator car.

27. The elevator system of claim 14, wherein the elevator system node is arranged in the elevator car.

28. The elevator system of claim 15, wherein the elevator system node is arranged in the elevator car.
